(19) United States
(12) Patent Application Publication
(10) Pub. No.: US 2023/0322480 A1
(43) Pub. Date: Oct. 12, 2023

(54) FRONT UNLOADING TRASH RECEPTACLE AND METHODS OF MAKING AND USING THE SAME

(71) Applicant: Justin Han Kim, Raleigh, NC (US)

(72) Inventor: Justin Han Kim, Raleigh, NC (US)

(21) Appl. No.: 17/958,766

(22) Filed: Oct. 3, 2022

Related U.S. Application Data
(60) Provisional application No. 63/329,461, filed on Apr. 10, 2022.

(51) Int. Cl. B65F 1/16; B65F 1/14

(52) U.S. Cl. CPC B65F 1/16; B65F 1/1415; B65F 1/1426

(57) ABSTRACT

The invention is directed to a trash receptacle that includes a hinged panel that can be opened or closed to access an interior garbage bag. The trash receptacle includes a series of panels that are joined together to create an interior sized and shaped to hold an amount of waste material. The receptacle also includes a closed bottom and an open top into which trash can enter the interior of the receptacle. The hinged panel can include a hinge, allowing the receptacle to be opened and closed. The receptacle can optionally include an upper lid that secures the hinged panel closed when not in use and can stabilize a garbage bag positioned within the interior of the receptacle. The receptacle can further optionally include an interior lip configured to contain any drips or spills that occur.

### CROSS-REFERENCE TO RELATED APPLICATIONS

This application claims priority to U.S. Provisional Patent Application No. 63/329,461 filed Apr. 10, 2022, the entire content of which is hereby incorporated by reference.

### BACKGROUND OF THE INVENTION

The present invention is in the field of receptacles to hold trash. More specifically, the present invention is in the technical field of household trash receptacles that may be commonly used in a kitchen. Kitchen trash receptacles are typically designed to be of a size and volume to accommodate a wide variety of objects that are disposed in a typical household kitchen and to minimize the frequency of emptying, typically in the range of 40-60 liters (10-16 gallons). To save floorspace, kitchen trash receptacles are typically much taller than they are wide or long. However, one current limitation of commercially available trash receptacles used in a typical kitchen is difficulty in removing a heavy or particularly full garbage bag, which must be lifted up and out of the trash receptacle. Pulling a heavy garbage bag up high enough for the bottom of the bag to extend above the top of the trash receptacle can be quite difficult for people who are weak (children and elderly), injured (especially injuries to the shoulders or back), and/or short in stature. A very full garbage bag and resulting friction with the inner surface of the trash receptacle may cause removal of the garbage bag to lift the trash receptacle itself, further complicating removal. Some people may not be able to perform this simple task without the help of another person. This simple action also has the potential to cause injury to the shoulders or back when the garbage bag is heavy. It would therefore be beneficial to provide a trash receptacle that overcomes the shortcomings of the prior art.

### SUMMARY OF THE INVENTION

In some embodiments, the presently disclosed subject matter is directed to a trash receptacle. Specifically, the receptacle is defined by an elongated housing comprising one or more sidewalls joined together to create an interior compartment, and a base positioned adjacent to a lower edge of the housing. The receptacle includes an open top that provides access to the interior compartment, and at least one hinged panel positioned in the housing, the hinged panel defined by a top edge, a bottom edge, and a pair of side edges. The receptacle includes a clasp that secures the hinged panel in a closed configuration wherein the hinged panel is adjacent to at least one sidewall, and wherein the clasp further provides an open configuration wherein the hinged panel is opposed to the at least one sidewall. The hinged panel provides access to the interior compartment in the open configuration.

In some embodiments, the hinged panel extends the full length of the associated sidewall.

In some embodiments, the hinged panel extends a portion of the full length of the associated sidewall.

In some embodiments, the hinged panel comprises a plurality of hinges.

In some embodiments, the hinged panel comprises at least one hinge positioned on a top or bottom edge of the panel.

In some embodiments, the hinged panel comprises at least one hinge positioned on a side edge of the panel.

In some embodiments, the hinged panel comprises at least one clasp positioned on a side edge, top edge, or bottom edge of the panel.

In some embodiments, the hinged panel is divided into at least two portions with a clasp positioned between the portions.

In some embodiments, the receptacle includes a lid positioned at a top edge of the housing.

In some embodiments, the receptacle includes a lip positioned adjacent to the base.

In some embodiments, the housing is configured in a trapezoidal cross-sectional shape.

In some embodiments, the receptacle is hinged into an upper movable portion and a lower stationary portion adjacent to the receptacle base.

In some embodiments, the hinged panel has a length and width that are greater than the length and width of each sidewall.

In some embodiments, the housing is configured in a square, rectangular, circular, or oval cross-sectional shape.

In some embodiments, the receptacle comprises a length, width, or both of about 5-35 inches.

In some embodiments, the receptacle comprises a height of about 5-50 inches.

In some embodiments, the presently disclosed subject matter is directed to a method of removing a garbage bag from a trash receptacle. Specifically, the method comprises inserting a first garbage bag into the interior compartment of the disclosed trash receptacle. The method includes maneuvering the hinged panel from the open configuration to the open configuration. The method includes removing the first garbage bag from the interior compartment of the receptacle using a forward motion, whereby a lifting motion is avoided. A lifting motion refers to a vertical motion from an upper location to a lower location and vice versa.

In some embodiments, the method includes removing a lid from an upper edge of the receptacle prior to maneuvering the hinged panel.

In some embodiments, the method includes inserting an empty garbage bag into the interior compartment of the receptacle and maneuvering the hinged panel to a closed position after the first garbage bag is removed.

### BRIEF DESCRIPTION OF THE DRAWINGS

FIG. 1a is a perspective view of a trash receptacle in a closed configuration without a garbage bag in accordance with some embodiments of the presently disclosed subject matter.

FIG. 1b is a perspective view of a trash receptacle in a closed configuration with a garbage bag in accordance with some embodiments of the presently disclosed subject matter.

FIG. 2a is a perspective view of a trash receptacle in an open configuration without a garbage bag in accordance with some embodiments of the presently disclosed subject matter.

FIG. 2b is a perspective view of a trash receptacle in an open configuration with a full garbage bag in accordance with some embodiments of the presently disclosed subject matter.

FIG. 2c is a perspective view of a trash receptacle in an open configuration, depicting removal of a garbage bag in accordance with some embodiments of the presently disclosed subject matter.

FIG. 3a is a perspective view of a trash receptacle in a closed configuration in accordance with some embodiments of the presently disclosed subject matter.

FIG. 3b is a perspective view of a trash receptacle in an open configuration in accordance with some embodiments of the presently disclosed subject matter.

FIG. 3c is a perspective view of a trash receptacle in a closed configuration in accordance with some embodiments of the presently disclosed subject matter.

FIG. 3d is a perspective view of a trash receptacle in a closed configuration with panels on each sidewall in accordance with some embodiments of the presently disclosed subject matter.

FIG. 4 is a perspective view of a trash receptacle in accordance with some embodiments of the presently disclosed subject matter.

FIG. 5a is a perspective view of a trash receptacle comprising an attached retention lid in accordance with some embodiments of the presently disclosed subject matter.

FIG. 5b is a perspective view of a trash receptacle with a removed retention lid in accordance with some embodiments of the presently disclosed subject matter.

FIG. 5c is a perspective view of a trash receptacle in an open configuration in accordance with some embodiments of the presently disclosed subject matter.

FIG. 6a is a perspective view of a trash receptacle in a closed configuration in accordance with some embodiments of the presently disclosed subject matter.

FIG. 6b is a top plan view of the trash receptacle of FIG. 6a.

FIG. 6c is a perspective view of a trash receptacle in an open configuration in accordance with some embodiments of the presently disclosed subject matter.

FIG. 6d is a top plan view of the trash receptacle of FIG. 6c.

FIG. 7a is a perspective view of a trash receptacle in a closed configuration in accordance with some embodiments of the presently disclosed subject matter.

FIG. 7b is a perspective view of a trash receptacle in an open configuration in accordance with some embodiments of the presently disclosed subject matter.

FIG. 8a is a perspective view of a trash receptacle comprising a bottom lip in a closed configuration in accordance with some embodiments of the presently disclosed subject matter.

FIG. 8b is a perspective view of a trash receptacle comprising a bottom lip in an open configuration in accordance with some embodiments of the presently disclosed subject matter.

FIG. 8c is a perspective view of a trash receptacle comprising a top and bottom lip in a closed configuration in accordance with some embodiments of the presently disclosed subject matter.

FIG. 9a is a perspective view of a trash receptacle in a closed configuration in accordance with some embodiments of the presently disclosed subject matter.

FIG. 9b is a perspective view of a trash receptacle in an open configuration in accordance with some embodiments of the presently disclosed subject matter.

FIG. 10 is a perspective view of a trash receptacle comprising a lid in accordance with some embodiments of the presently disclosed subject matter.

### DETAILED DESCRIPTION OF THE INVENTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

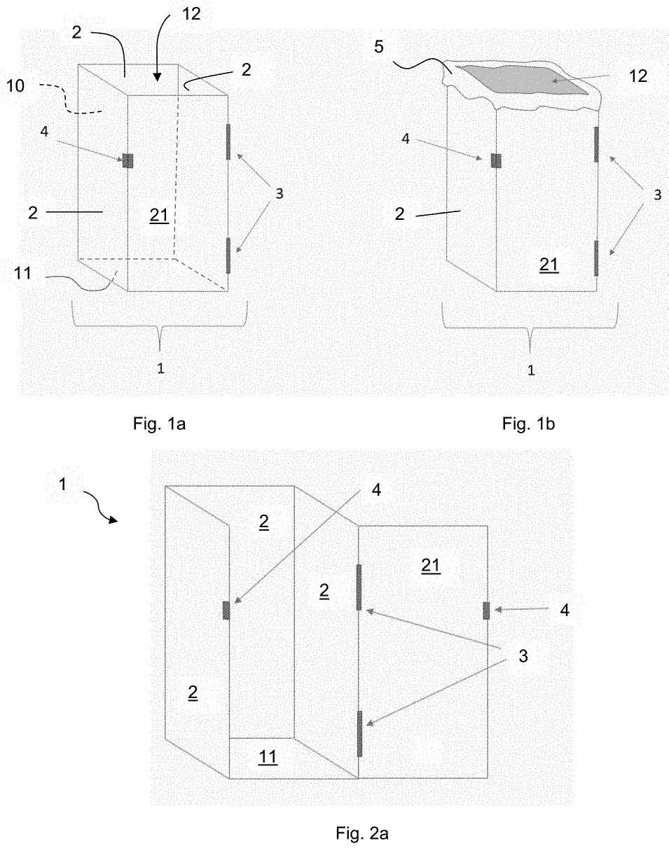

The present disclosure generally provides a trash receptacle that includes a hinged panel that can be opened or closed to access an interior garbage bag. The term “trash receptacle” as used herein generally refers to any type of container that can be used to hold trash. The term “trash” refers to any type of waste, such as (but not limited to) food waste, paper, packaging (bottles, cans, wrappers), and any other type of unwanted waste material. FIG. 1a illustrates one embodiment of trash receptacle 1 comprising an elongated, substantially vertically oriented housing comprising one or more sidewalls 2 that are joined together to create interior 10 sized and shaped to hold an amount of waste material. The receptacle also includes base 11 that provides a surface upon which a garbage bag rests. The receptacle further includes open top 12 for providing access to the interior compartment of the receptacle. Trash is deposited into the interior compartment through open top 12 (e.g., into garbage bag 5 that fits within the receptacle interior to collect the waste).

At least one panel 21 can be formed in a portion of sidewall 2, allowing the receptacle to be opened and closed. Panel 21 can extend from a bottom edge to a top edge of the sidewall, forming a side door. The panel can be secured to the sidewall by one or more hinges 3 that lie flush against the exterior surface of the sidewall. The term “hinge” refers broadly to any jointed or flexible device that connects or permits pivoting, moving, or turning of one panel relative to a receptacle sidewall. Garbage bag 5 can be positioned within interior 10 of trash receptacle, as illustrated in FIG. 1b. The garbage bag can be configured as any container element that can be added or removed from the interior of the receptacle, holding a volume of discarded trash. The hinged panel is movable between a closed position for sealing the panel to an adjacent sidewall and an open position that provides selective access to interior compartment 10. In this way, panel 21 allows easy access to garbage bag 5, while also securing the garbage bag within the interior compartment.

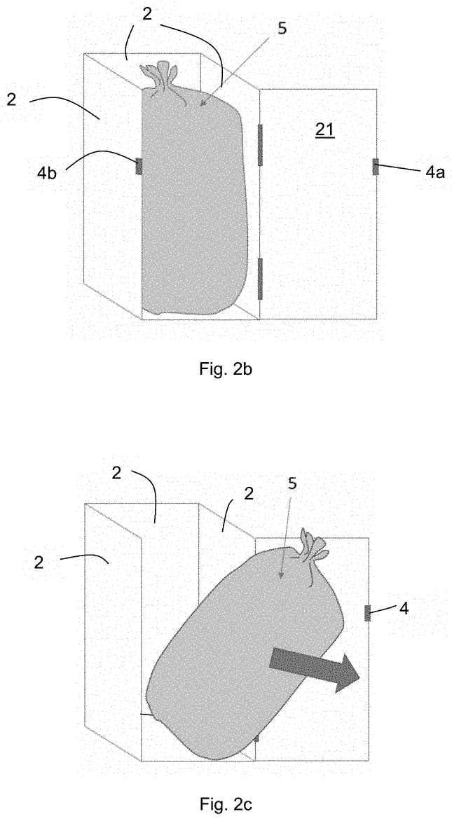

As set forth above, the disclosed receptacle includes one of more hinged panels that can be swung open and closed to allow access to receptacle interior 10. For example, FIG. 2a illustrates one embodiment of receptacle 1 in an open configuration, such that the receptacle interior is accessible. The hinged panel can comprise the entire side(s) or nearly the entire side(s) of the receptacle. In the open embodiment, a user can add or remove an associated garbage bag, as shown in FIGS. 2b and 2c.

Panel 21 can include any number of hinges (e.g., about 1-5 or more) depending on the size of receptacle 1. In some embodiments, the hinges secure one vertical side edge of each hinged panel to the remainder of the sidewall for outward pivotal movement relative to interior compartment 10. The hinges can be evenly distributed along one edge of panel 2 or can be clustered in groups of two or more.

A hinged panel can be secured to an adjacent panel 2 using clasp 4. The term “clasp” broadly refers any closure mechanism, such as a latch, a fastener, handle, catch, magnetic securement, or other conventional closure device. In some embodiments, the clasp will include first portion 4a positioned on an edge of the hinged panel, and second portion 4b positioned on the adjoining edge of an adjacent panel or sidewall, as shown in FIG. 2b. Panel 21 can include any number of clasps. Clasp portions 4a and 4b can have a first configuration where they are removably secured together (thereby closing the receptacle panel as shown in FIG. 1b) and a second configuration where they are separated (where the panel is open as shown in FIG. 2b).

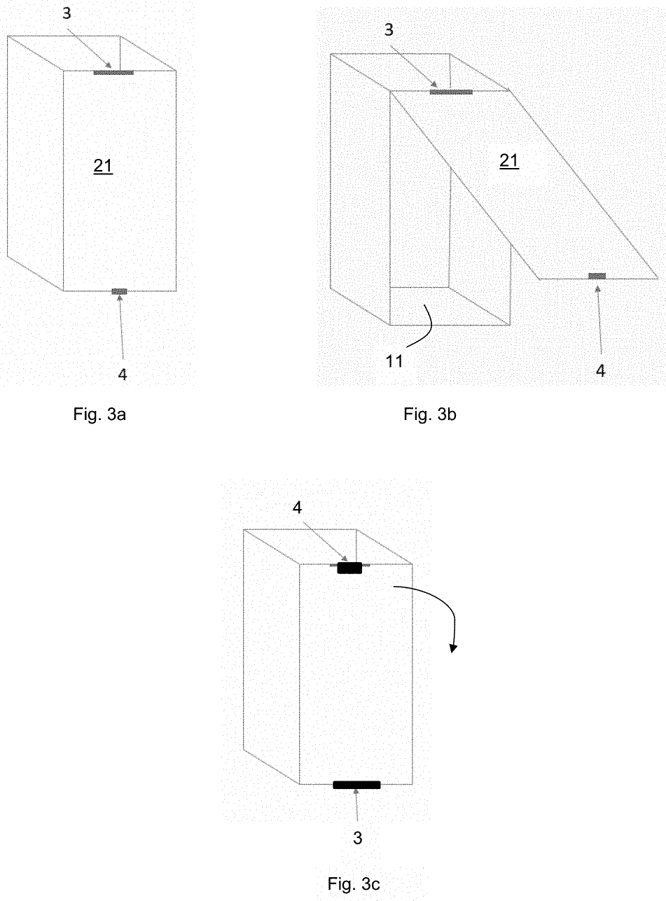

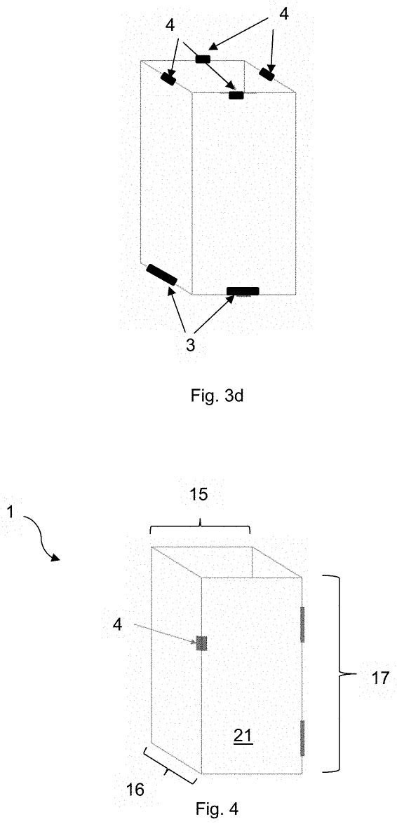

FIG. 3a illustrates one embodiment of hinge 3 and clasp 4 positioned along a top or bottom edge of the receptacle. In such embodiments, the hinged panel can open from the bottom up, as shown in FIG. 3b. It should be appreciated that the inverse is also true, and hinge 3 can be positioned adjacent to bottom face 11, such that the hinged panel opens from the top down, as shown in FIG. 3c. In some embodiments each sidewall 2 of the receptacle can be configured as a panel to allow the device to accommodate any enclosure (e.g., cabinet, bin, and the like). Thus, each sidewall 2 can include clasp 4 and opposed hinge(s) 3. For example, if the receptacle is configured in a rectangular shape with 4 sidewalls, each sidewall can include panel 21 to allow any side to be opened or closed to access the garbage bag, as illustrated in FIG. 3d.

Receptacle 1 can be configured in any suitable dimensions, as illustrated in FIG. 4. For example, the receptacle can have length 15 and/or width 16 of about 5-35 inches (e.g., at least/no more than about 5, 10, 15, 20, 25, 30, or 35 inches). The term “length” refers to the longest horizontal straight-line distance of the receptacle. The term “width” refers to the longest straight line distance perpendicular to the length (e.g., from a front surface to a rear surface). The receptacle can also include height 17 of about 5-50 inches (e.g., at least/no more than about 5, 10, 15, 20, 25, 30, 35, 40, 45, or 50 inches). The term “height” refers to the longest straight-line distance from a bottom surface to a top surface of the receptacle. It should be appreciated that the length, width, and height of the receptacle is not limited to the ranges given above.

The shape of panel 21 is illustrated as being rectangular, as shown in FIG. 2b. However, it should be noted that other functional shapes can be used.

Trash receptacle 1 can be constructed from any desired rigid or semi-rigid material.

The term “rigid” refers to a material that does not flex or bend when subjected to typical forces experienced by a trash receptacle during use. The term “semi-rigid” refers to a material that is somewhat stiff and solid, but not inflexible and configured to bend without breaking. Accordingly, receptacle 1 can be constructed from wood, plastic, metal, ceramics, cardboard, carbon fiber material, or combinations thereof.

Further, receptacle 1 can be constructed using conventional methods. For example, injection molding, stamping, rolling and/or welding can be used.

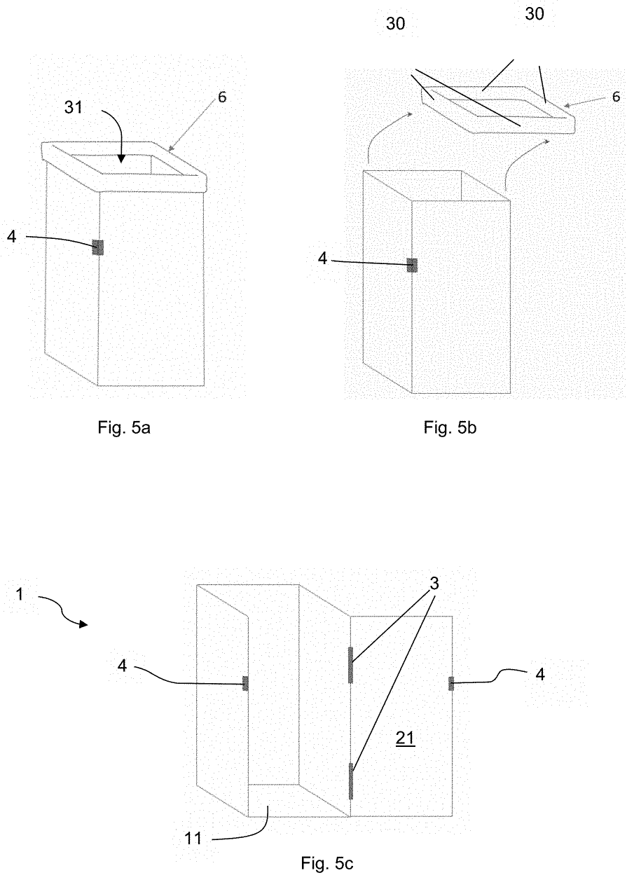

In some embodiments, receptacle 1 can include retention lid 6 configured on an upper edge to provide stability and to retain garbage bag 5 within the receptacle interior 12, as shown in FIG. 5a. Specifically, the loose ends of the garbage bag positioned at the open end of the receptacle can be retained by fitting lid 6 over the open end, thereby holding the bag in place. As such, the retention lid should have the same cross-sectional shape at the upper edge of the receptacle. It should be appreciated that the lid includes a series of interconnected side edges 30 and central opening 31 that allows garbage to be placed within the receptacle (e.g., garbage bag) interior.

Lid 6 can be quickly removed by the user, such as when replacing or removing a garbage bag. Specifically, the user can easily lift lid 6 from the upper edge of the receptacle for removal. Once removed, a garbage bag can be fitted within the interior of the receptacle, extending above the upper edge. The lid can then be replaced at the top edge of the receptacle, thereby securing garbage bag 5 in place. Thus, the lid can freely sit on the top edge of the receptacle so that it can be easily lifted on/off the receptacle. In other embodiments, the lid can include any conventional securing mechanism that removably attaches the lid to the receptacle, such as clips, fasteners, magnets, and the like.

It should be appreciated that lid 6 must be removed prior to opening hinged panel 21 to allow the panel to swing open and the interior compartment to be accessed, as shown in FIGS. 5b and 5c. In this way, the lid acts as a securing element, preventing the panel from swinging open inadvertently. After the trash bag has been removed, the lid can be replaced on the top edge of the receptacle to stabilize the garbage bag and prevent unnecessary movement or slippage from the upper surface. The lid can further help retain the garbage bag in proper position (e.g., preventing the bag opening from slipping into the interior of the receptacle).

The overall dimensions and shape of the trash receptacle can range widely to accommodate a variety of uses. For example, the panels can be joined together to form a square, rectangular, circular, oval, triangular, hexagonal, and the like cross-sectional shape. However, the cross-sectional shape of the receptacle is not limited and can be configured in any desired shape, including a complex hybrid shape.

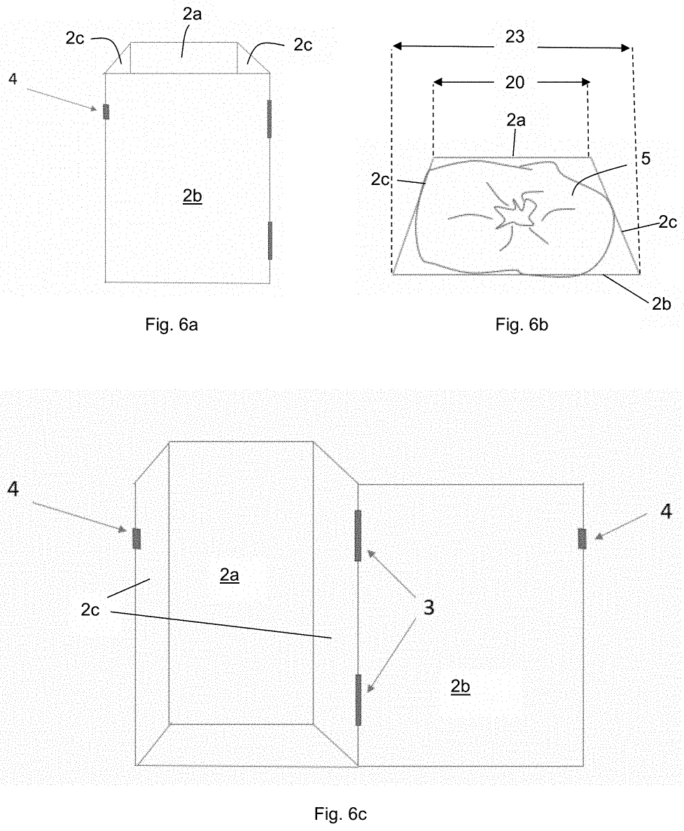

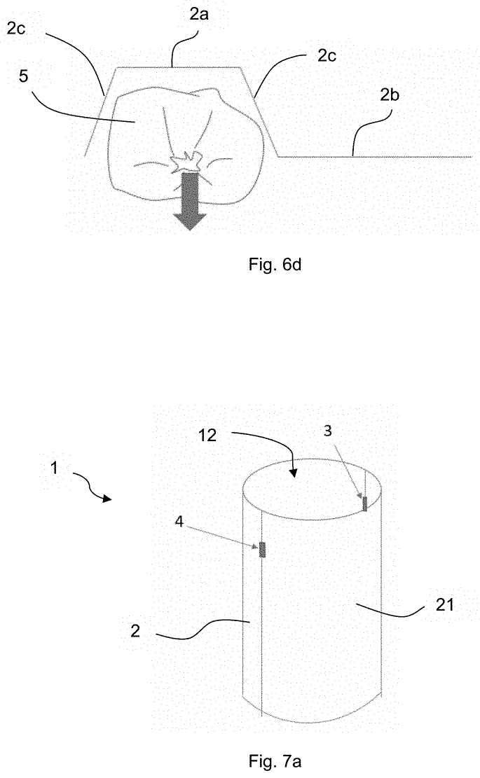

Thus, trash receptacle 1 can have a trapezoidal cross-sectional shape, as shown in FIGS. 6a and 6b. As shown, rear sidewall 2a can have a length 20 that is less than the length 23 of front sidewall 2b. The length of side sidewalls 2c can be about the same as each other. As illustrated, the hinged panel can form the longest wall of the trapezoid to minimize the amount of friction exerted by a full garbage bag on the interior walls of the receptacle. As a result, removal of a full garbage bag is streamlined and made easier and more efficient, as shown in the open configuration of FIGS. 6c and 6d. Thus, the trapezoidal shape allows the hinged panel to more easily open and close.

FIGS. 7a and 7b illustrate one embodiment of receptacle 1 with a circular or ovoid configuration comprising singular sidewall 2, open top end 12, and closed bottom 11. Panel 21 is configured on a portion of the sidewall, allowing the receptacle to be opened and closed as described above. In some embodiments, hinge 3 and clasp 4 are aligned in the round configuration (e.g., an imaginary line from the side edges of panel 21 can make up the approximate diameter or midpoint of the receptacle as shown in FIG. 7a.

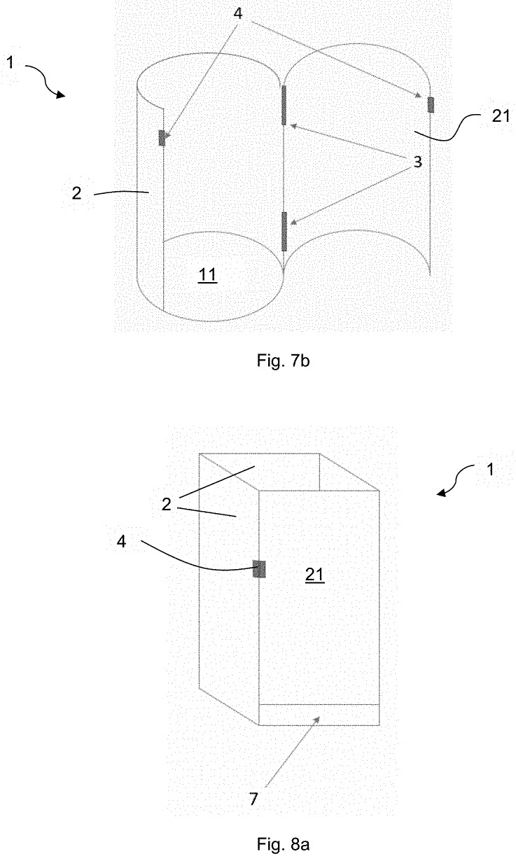

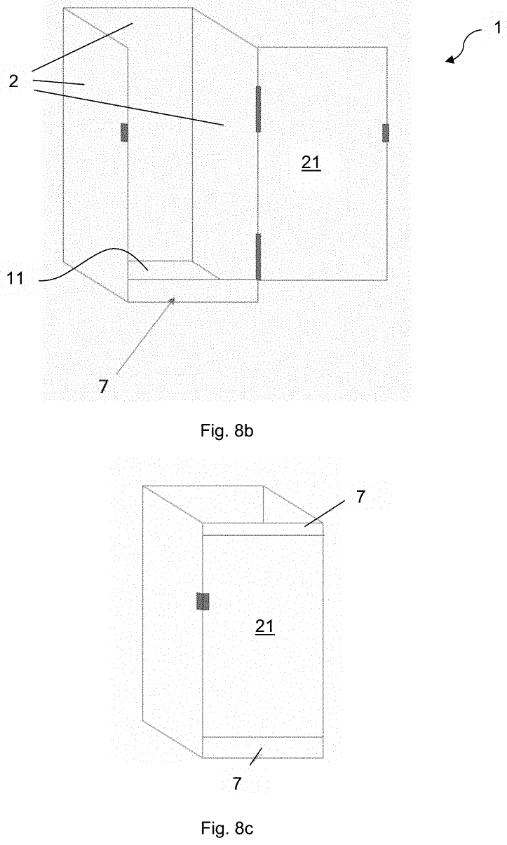

In some embodiments, panel 21 of trash receptacle 1 can include rim 7 positioned adjacent to a top, side, and/or bottom surface, as shown in FIGS. 8a-8c. Stated another way, the bottom edge of panel 21 can be raised from and adjacent to the rim. Rim 7 ensures that any fluids that accumulate in the bottom of the receptacle cannot easily leak or drip, causing a mess in the surrounding environment. The rim can be continuous and/or fixed to bottom surface 11, providing a circumferential seamless bottom.

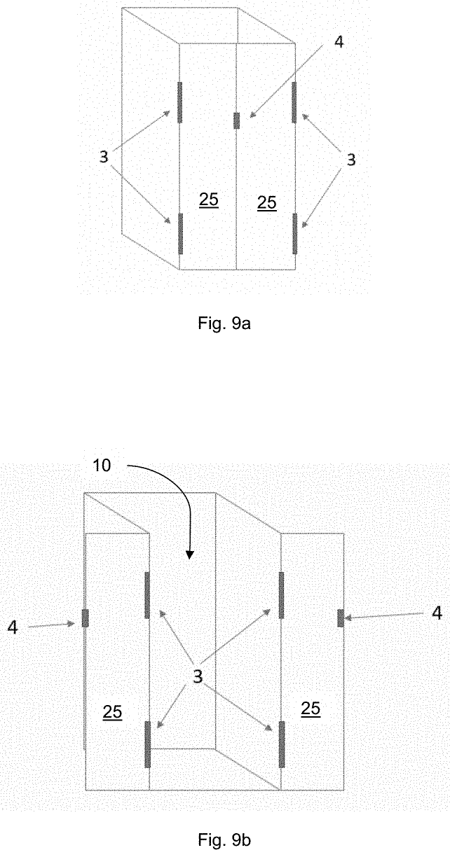

FIG. 9a illustrates one embodiment of receptacle 5 comprising a hinged panel divided into first and second segments 25 that cooperate to provide access to interior 10. As described previously, the clasp 4 can removably secure the segments together until a user desires to add or remove a garbage bag, as shown in FIG. 9b.

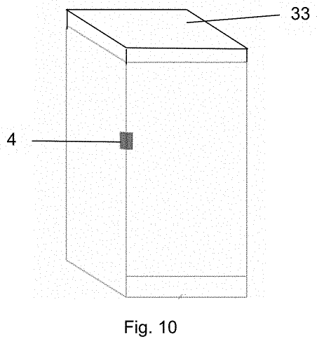

Optionally, receptacle 1 can include cover 33 that fits over the top edge, as shown in FIG. 10. The cover can function to retain odors that emanate from the garbage bag, preventing them from escaping. The cover can include any desired shape or size. The cover can be used independently of lid 6 (e.g., alone) or can be used in addition to the receptacle lid.

While the current description is for a trash receptacle for the kitchen, it is applicable for any receptacle designed to hold refuse of any type, from household refuse to construction debris. The receptacle can also be utilized to store objects that are deposited from its top opening.

In use, garbage bag 5 can be inserted into interior 10 of the trash receptacle such that the open bag end is adjacent to top edge 12. In some embodiments, lid 6 can be positioned on the top edge of the receptacle, thereby anchoring the garbage bag, and preventing slippage. However, lid 6 is optional. The receptacle can then be used to collect trash (e.g., users throw trash into the open top end 12 and it accumulates within the garbage bag interior). When garbage bag 5 is full, it can be easily and quickly emptied by removing lid 6 (if present). Hinged panel 21 can then be swung open, providing access to the receptacle interior. The user can easily grasp the garbage bag and remove it using a forward motion. The term “forward motion” refers to a motion from a first location to a second location that is horizontal relative to the first location (e.g., from a back location to a location in front of the back location). Once the hinged panel is opened, the user has an unrestricted and enlarged area for the dislodging and removal of garbage bag 5. For example, the garbage bag can be removed by simply pulling it out laterally from interior compartment 10 to the exterior of the receptacle. A new garbage bag 5 can be applied to receptacle, either before or after the hinged panel is closed. Optionally, lid 6 can then be reapplied over the open end to secure the garbage bag in place.

The sliding action does not require the user to lift the filled garbage bag above the level of the upper edge of the receptacle, as would be found with conventional trash containers. The lack of the lifting requirement allows users with weight-lifting limitations or other physical disabilities to easily utilize the side opening trash receptacle. The side opening feature would also be enjoyed by users that experience aggravation when trying to remove a filled garbage bag from a conventional trash container and vacuum pressure prevents them from doing so.

In some embodiments, the hinged panel can be manually opened by a user (e.g., through the application of light pressure). Alternatively, the clasp can be controlled by a mechanical foot pedal, open/close mechanism, or an automated mechanism to open or close the hinged panel on demand. If by a foot pedal, the hinged panel can be released by applying downward or upward pressure on a lever. In some embodiment, pressing the lever can have multifunctionality, such that it can both raise the lid and open the hinged panel. The mechanism by which a foot pedal secures the door closed can be mechanical or magnetic.

While the receptacle is in the open configuration, a user can also easily wipe out, clean, and/or sanitize the interior and exterior of the receptacle. The cleaning is much more convenient compared to conventional trash containers, which encourages a healthier living environment.

The disclosed trash receptacle offers many advantages over prior art receptacles. For example, receptacle 1 can provide easy side open access to dispose of a garbage bag contained within the interior compartment of the receptacle.

In addition, the disclosed receptacle eliminates upward removal of a garbage bag contained within interior compartment 10 during trash disposal.

Receptacle 1 can be manufactured in varying sizes and shapes, allowing the device to be used in a number of diverse environments.

The disclosed trash receptacle is simple and does not require the use of excessive parts. As such, the receptacle is inexpensive to manufacture. This savings, if passed on to the consumer, may influence the public to utilize such a device. A simple design also increases product reliability and useful product lifetime.

The receptacle is easy to use, allowing even children, the elderly, and the physically disabled (e.g., those with bad backs) to remove a full garbage bag and insert a new bag.

Receptacle 5 can be easily cleaned and sanitized to allow for healthy use and living conditions.

The disclosed receptacle allows a garbage bag to be quickly and efficiently removed, thereby saving time.

Another advantage of the disclosed receptacle is that it provides independence to users who are unable to lift heavy weights or are afflicted by physical disabilities.

The receptacle can be it is easily produced from readily available materials using known manufacturing techniques, thus allowing for an economical and practical product.

The foregoing description is included to illustrate the operation of the preferred embodiment and is not meant to limit the scope of the invention. The scope of the invention is to be limited only by the following claims.

What is claimed is:

1. A trash receptacle defined by:
an elongated housing comprising one or more sidewalls joined together to create an interior compartment;
a base positioned adjacent to a lower edge of the housing;
an open top that provides access to the interior compartment;
at least one hinged panel positioned in the housing, the hinged panel defined by a top edge, a bottom edge, and a pair of side edges;
a clasp that secures the hinged panel in a closed configuration wherein the hinged panel is adjacent to at least one sidewall, and wherein the clasp further provides an open configuration wherein the hinged panel is opposed to the at least one sidewall;
wherein the hinged panel provides access to the interior compartment in the open configuration.

2. The receptacle of claim 1, wherein the hinged panel comprises at least one hinge positioned on a top or bottom edge of the panel.

3. The receptacle of claim 1, wherein the hinged panel comprises at least one hinge positioned on a side edge of the panel.

4. The receptacle of claim 1, wherein the hinged panel comprises at least one clasp positioned on a side edge, top edge, or bottom edge of the panel.

5. The receptacle of claim 1, wherein the hinged panel is divided into at least two portions with a clasp positioned between the portions.

6. The receptacle of claim 1, further comprising a lid positioned at a top edge of the housing.

7. The receptacle of claim 1, wherein the hinged panel includes an upper movable portion and a lower stationary portion adjacent to the receptacle base.

8. The receptacle of claim 1, wherein the hinged panel includes a lower movable portion and an upper stationary portion adjacent to a top edge of the receptacle.

9. The receptacle of claim 1, wherein the hinged panel has a length and width that are greater than a length and width of each sidewall.

10. The receptacle of claim 1, wherein the housing has a trapezoidal cross-sectional shape.

11. A method of removing a garbage bag from a trash receptacle, the method comprising:
inserting a first garbage bag into the interior compartment the trash receptacle of claim 1;
maneuvering the hinged panel from the open configuration to the open configuration;
removing the first garbage bag from the interior compartment of the receptacle using a forward motion;
whereby a lifting motion is avoided.

12. The method of claim 11, further comprising removing a lid from an upper edge of the receptacle prior to maneuvering the hinged panel.

13. The method of claim 11, further comprising inserting an empty garbage bag into the interior compartment of the receptacle and maneuvering the hinged panel to a closed position after the first garbage bag is removed.

14. The method of claim 11, wherein the hinged panel comprises at least one hinge positioned on a top or bottom edge of the panel.

15. The method of claim 11, wherein the hinged panel comprises at least one hinge positioned on a side edge of the panel.

16. The method of claim 11, wherein the hinged panel comprises at least one clasp positioned on a side edge, top edge, or bottom edge of the panel.

17. The method of claim 11, wherein the hinged panel is divided into at least two portions with a clasp positioned between the portions.

18. The method of claim 11, wherein the hinged into an upper movable portion and a lower stationary portion adjacent to the receptacle base.

19. The method of claim 11, wherein the hinged panel has a length and width that are greater than the length and width of each sidewall.

20. The method of claim 11, wherein the housing has a square, rectangular, circular, or oval cross-sectional shape.
